(19) United States
(12) Patent Application Publication
(10) Pub. No.: US 2023/0391239 A1
(43) Pub. Date: Dec. 7, 2023

(54) MULTI-FUNCTIONAL CENTER CONSOLE

(71) Applicant: Indiev, Inc, Los Angeles, CA (US)

(72) Inventors: Andre Hudson, Los Angeles, CA (US); Young Joon Ju, Los Angeles, CA (US)

(21) Appl. No.: 17/805,519

(22) Filed: Jun. 6, 2022

(51) Int. Cl. B60N 2/75; B60K 35/00; B60N 3/10; H02J 50/00

(52) U.S. Cl. CPC B60N 2/793; B60K 35/00; B60N 2/797; B60N 3/101; H02J 50/00; B60K 2370/164; B60K 2370/774

(57) ABSTRACT

Center consoles for passenger vehicles are provided and include a main body, an inner storage area comprising at least one removable inner storage container, and an armrest lid over the inner storage area and able to be opened or closed. The center console can include multiple storage areas and electronic components.

### BACKGROUND

Passenger vehicles often have center consoles between the front driver seat and the front passenger seat. Consumers are generally interested in center consoles that provide more than one function.

### BRIEF SUMMARY

Embodiments of the subject invention provide novel and advantageous center consoles for passenger vehicles. A center console can include a main body, an inner storage area comprising at least one removable inner storage container, and an armrest lid over the inner storage area and able to be opened or closed. The center console can include multiple storage areas for increased utility and can also include electronic components (e.g., charging ports or areas) for a better digital experience in the digital vehicle.

In an embodiment, a center console for a passenger vehicle can comprise: a main body; an inner storage area comprising at least one removable inner storage container; and an armrest lid disposed over the inner storage area and having an opened position and a closed position. When the armrest lid is in the closed position, it can close off the inner storage area and when the armrest lid is in the opened position, it can allow access to the inner storage area. The armrest lid can comprise a swing-top push lid that is configured to be pushed inward towards the inner storage area and allow access thereto when the swing-top push lid is pushed inward. The swing-top push lid can be configured to return to a closed position when it is not being pushed inward by a user of the passenger vehicle.

The at least one inner storage container can comprise a first inner storage container and a second inner storage container, and the first inner storage container can be disposed forward of the second inner storage container such that it is closer to a front face of the center console than is the second inner storage container. The swing-top push lid can be disposed directly over the second inner storage container. The first inner storage container can have a larger height and a larger volume than does the second inner storage container. The inner storage area can comprise a first section configured to receive and hold in place the first inner storage container and a second section configured to receive and hold in place the second inner storage container. The armrest lid can further comprise a window disposed forward of the swing-top push lid such that it is closer to a front face of the center console than is the swing-top push lid, and the window can be disposed directly over the first inner storage container. The window can comprise at least one of transparent plastic and glass. The center console can further comprise a charging area outside of and adjacent to the inner storage area, and the charging area can be disposed forward of at least a majority of the inner storage area. The charging area can comprise a wireless charging pad for charging electronic devices. The center console can further comprise: a lip disposed around at least a portion of the charging area to inhibit any items disposed in the charging area from falling; a cup holder section disposed in a forward area of the center console and comprising space for at least two cups; a flat landing area adjacent to the cup holder section; and/or a sloping section disposed between the landing area and a charging area of the center console. The sloping section can comprise a first section that slopes towards a rear face of the center console as it goes from the charging area towards the landing area and a second section that slopes towards a front face of the center console as it goes from the first section towards the landing area. The center console can further comprise: a stationary armrest portion that does not open or close with the armrest lid and stays in place while the armrest lid opens, the stationary armrest portion being disposed adjacent to the armrest lid and at a rear area of the center console; and/or a hinge that can be directly connected to the stationary armrest portion and/or the armrest lid. The hinge can be configured to allow the armrest lid to alternate between the opened position and the closed position. A front face of the center console can comprise an indicator light and a front electronic connection portion comprising at least one front connection port, and each front connection port can be configured to allow an electronic device to be: charged; connected to an infotainment system or an entertainment system of the passenger vehicle; or both. The front face can comprise a vertical portion and a slanted portion that slants inward from the vertical portion; the slanted portion can be disposed below the vertical portion on the front face; and the front electronic connection portion and the indicator light can be disposed on the slanted portion of the front face closer to the vertical portion than they are to a lowermost area of the slanted portion. A rear face of the center console can comprise at least one vent and a rear electronic connection portion comprising at least one rear connection port. Each rear connection port can be configured to allow an electronic device to be: charged; connected to an infotainment system or an entertainment system of the passenger vehicle; or both. The at least one vent can be configured to provide air from a climate control system of the passenger vehicle. The rear face can comprise a lower slanted portion that slants inward and a protruded portion that protrudes outward from a remainder of the rear face.

In another embodiment, a passenger vehicle can comprise: a driver seat; a front passenger seat; and a center console as described herein disposed between the driver seat and the front passenger seat. The passenger vehicle can further comprise: a source of power; a climate control system; and/or an infotainment system. The center console can be connected to the power, the climate control system, and/or the infotainment system. The passenger vehicle can be an electric vehicle.

### BRIEF DESCRIPTION OF DRAWINGS

FIG. 1 shows a top view of a center console, according to an embodiment of the subject invention.

FIG. 2 shows a front view of a center console, according to an embodiment of the subject invention.

FIG. 3 shows a side view of a center console (looking from the left of the console), according to an embodiment of the subject invention.

FIG. 4 shows a rear view of a center console, according to an embodiment of the subject invention.

FIG. 5 shows a perspective front view of a center console (looking from the front-left of the console), according to an embodiment of the subject invention.

FIG. 6 shows a perspective rear view of a center console (looking from the rear-left of the console), according to an embodiment of the subject invention.

FIG. 7A shows a perspective front view of a front portion of a center console (looking from the rear-left of the console), according to an embodiment of the subject invention.

FIG. 7B shows a perspective front view of a front portion of a center console (looking from the rear-left of the console), according to an embodiment of the subject invention, with objects placed in the console.

FIG. 8A shows a front view of a center console, according to an embodiment of the subject invention.

FIG. 8B shows a perspective front view of a center console (looking from the front-left of the console), according to an embodiment of the subject invention.

FIG. 9 shows a side perspective view of a center console (looking from the left of, and above, the console), according to an embodiment of the subject invention. The inset shows a straight-on side view of the center console (looking from the left of the console). In both views, inner storage containers are highlighted.

FIG. 10A shows a top view of a center console, according to an embodiment of the subject invention. A portion of an inner storage container can be seen through a window.

FIG. 10B shows a side view of the center console (looking from the left of the console) of FIG. 10A. The dotted lines between FIGS. 10A and 10B indicate the same portion of the console.

FIG. 11 shows a side perspective view of a center console (looking from the left of, and above, the console), according to an embodiment of the subject invention. The armrest lid is depicted as open, and inner storage containers can be seen.

FIG. 12A shows a side perspective view of a center console (looking from the left of, and above, the console), according to an embodiment of the subject invention.

FIG. 12B shows a cross-sectional view of a portion of the center console (looking from the left of the console) of FIG. 12A. The inner storage containers are highlighted, and the swing-top push lid over one of the inner storage containers is shown opening.

FIG. 12C shows a side perspective view of the center console (looking from the left of, and above, the console) of FIGS. 12A and 12B. The swing-top push lid is depicted in an open position. The dotted lines between FIGS. 12B and 12C indicate the same portion of the console.

FIG. 13A shows a side perspective view of a center console (looking from the left of, and above, the console), according to an embodiment of the subject invention. The armrest lid is depicted as open, and inner storage containers can be seen starting to be removed from the center console.

FIG. 13B shows a perspective view of the inner storage containers.

FIGS. 14A-14F depict storage of objects in an inner storage container of the center console, removal of an object, and insertion of a waste object into another inner storage container of the center console. FIG. 14A shows a side perspective view of the center console (looking from the left of, and above, the console), according to an embodiment of the subject invention. The inner storage containers are highlighted, as are objects placed in one of the inner storage containers. In this case, the objects are soda cans, which are depicted for exemplary purposes only. FIG. 14B shows the armrest lid of the center console in an opened position, and the inner storage containers can be seen, as can the soda cans. FIG. 14C depicts a soda can being removed from the inner storage container of the center console. FIG. 14D depicts a used soda can being inserted via the swing-top push lid into the other inner storage container. FIG. 14E shows the armrest lid opened and the inner storage container with the waste objects therein being removed. FIG. 14F depicts the removed inner storage container being tipped so the waste therein can be dumped or otherwise transferred to a waste bin or other waste receptacle.

### DETAILED DESCRIPTION

Embodiments of the subject invention provide novel and advantageous center consoles for passenger vehicles. A center console can include a main body, an inner storage area comprising at least one removable inner storage container, and an armrest lid over the inner storage area and able to be opened or closed. The center console can include multiple storage areas for increased utility and can also include electronic components (e.g., charging ports or areas) for a better digital experience in the digital vehicle.

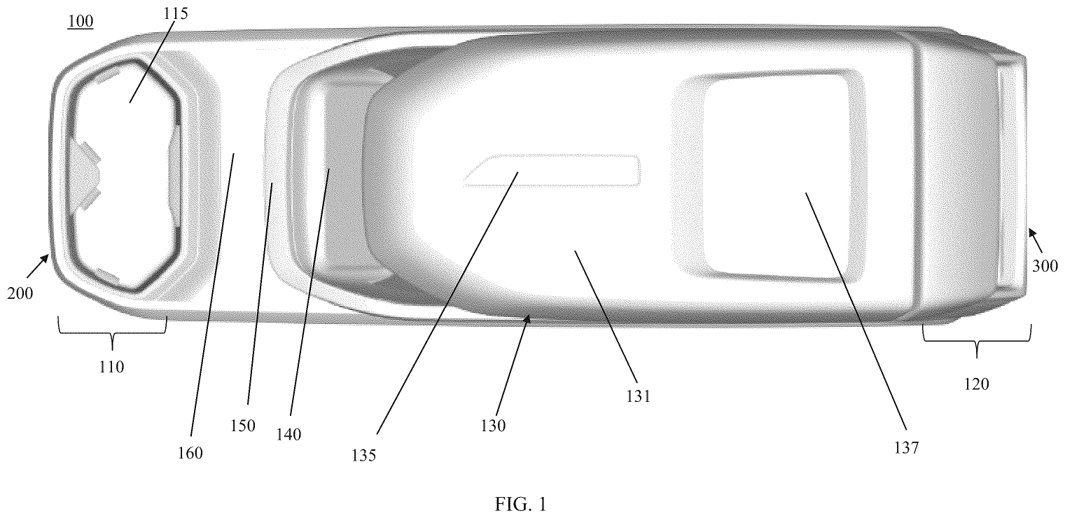

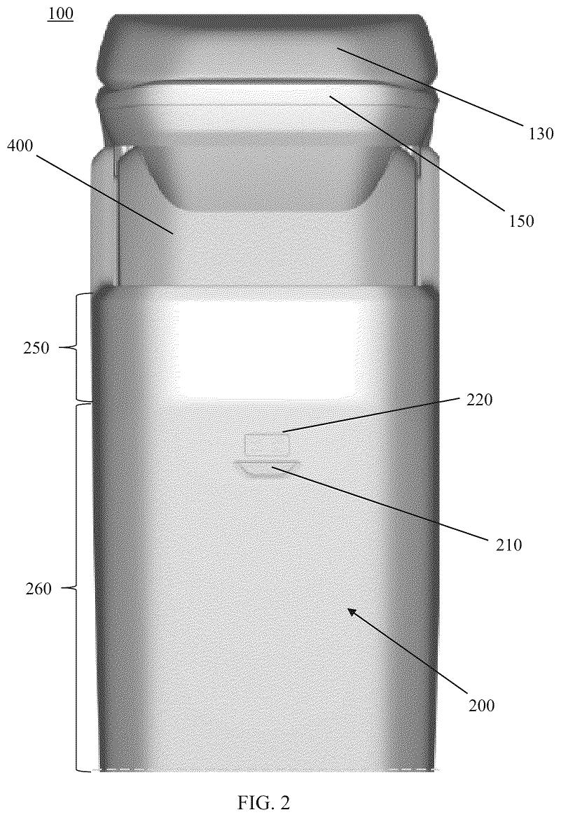

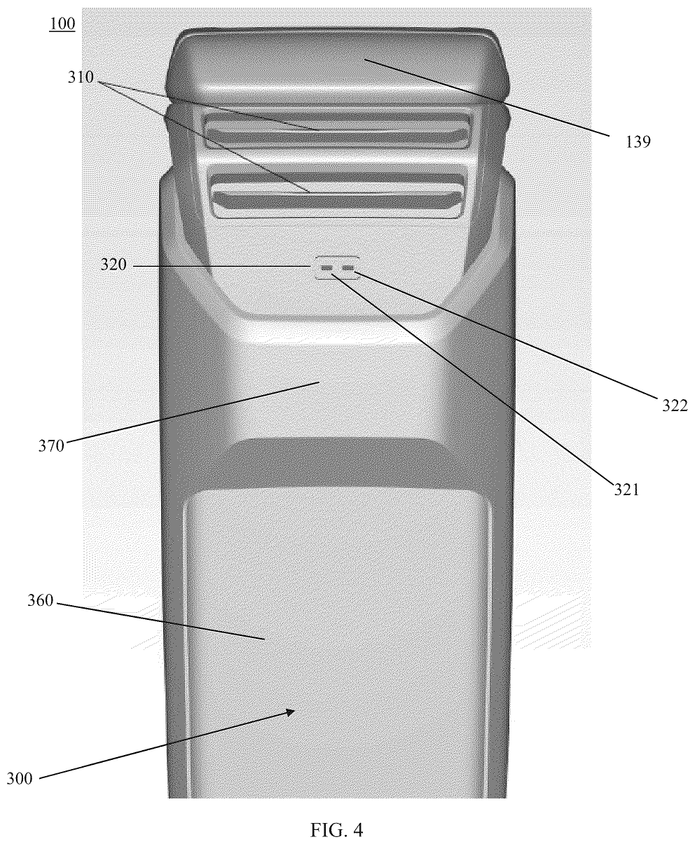

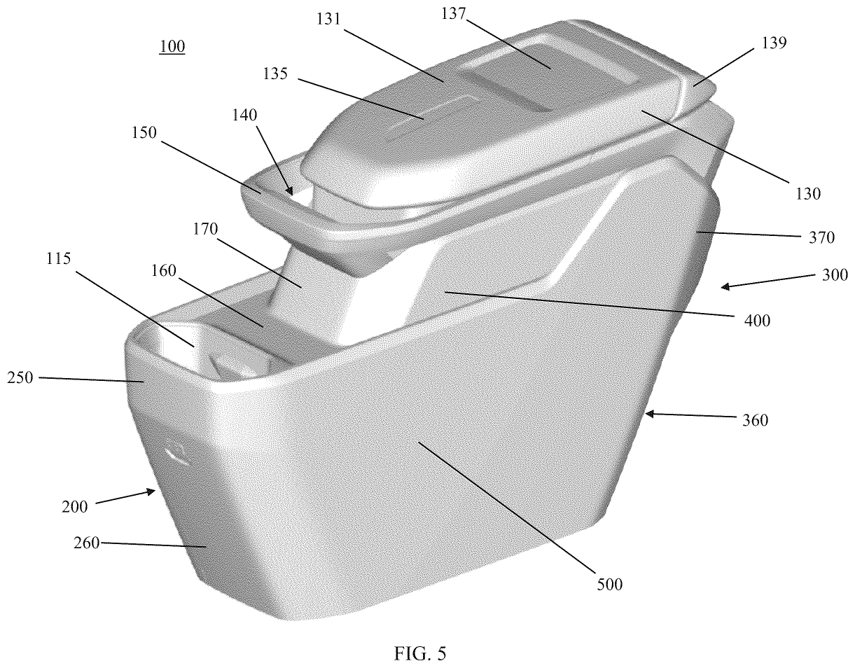

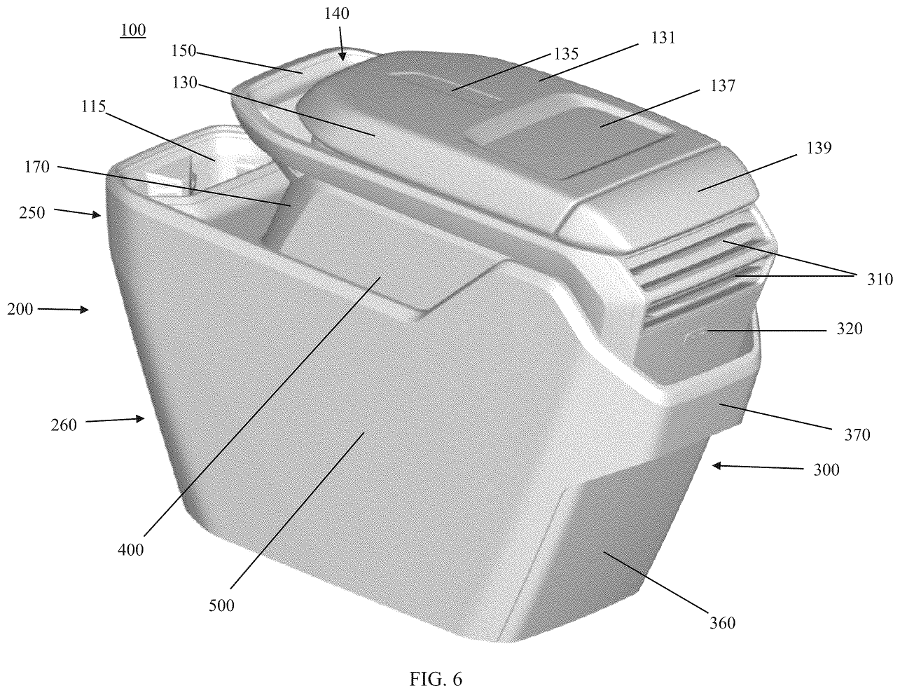

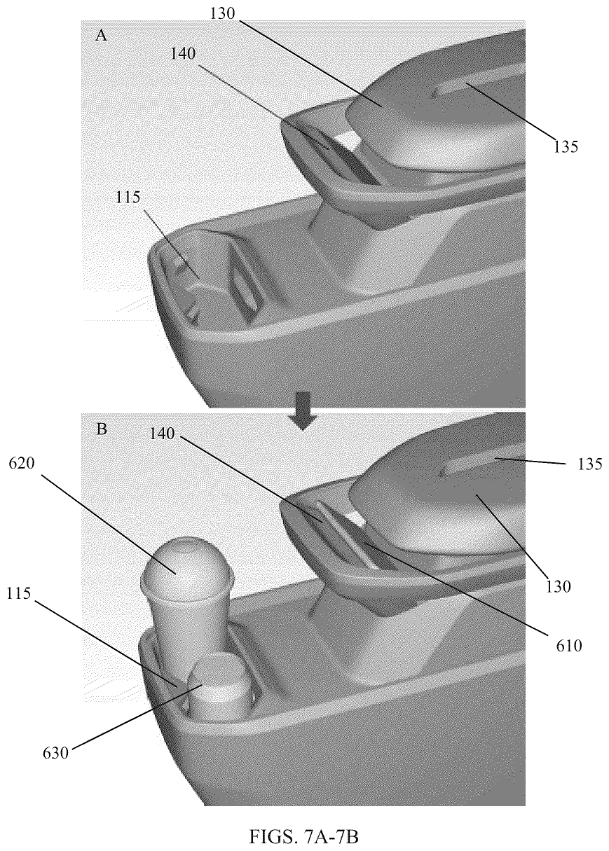

FIGS. 1-6 show top, front, side, rear, front perspective, and rear perspective views, respectively, of a center console according to an embodiment of the subject invention. Referring to FIGS. 1-6, the center console 100 can include a main body 500, an inner storage area 400, and an armrest lid 130 over the inner storage area configured to be opened or closed (e.g., via a hinge connected to the stationary armrest portion 139). The inner storage area 400 can extend downward into the main body 500 (e.g., all the way down to the bottom of the center console 100, or some portion thereof). The armrest lid 130 can be adjacent to the stationary armrest portion 139 that does not open or close with the armrest lid 130 but instead stays in place while the armrest lid 130 opens. The arrest lid 130 and/or the stationary armrest portion 139 can have some cushioning and/or give instead of being completely rigid, in order to provide comfort when a user's arm is rested thereon; though, embodiments are not limited thereto. The center console 100 can further include a charging area 140 (e.g., a wireless charging pad), a lip 150 adjacent (or around) the charging area 140, a cup holder section 115, a landing area 160 adjacent to the cup holder section 115, and a sloping section 170 between the landing area 160 and the lip 150 and charging area 140. The charging area 140 can be used to charge an electronic device (e.g., a smartphone), such as via wireless charging. The cup holder section 115 can include, for example, space for two cups of either the same or different sizes. FIGS. 7A and 7B show an example of an electronic device 610 being wirelessly charged on the charging area 140, as well as a cup 620 and a can 630 being disposed in the cup holder section 115.

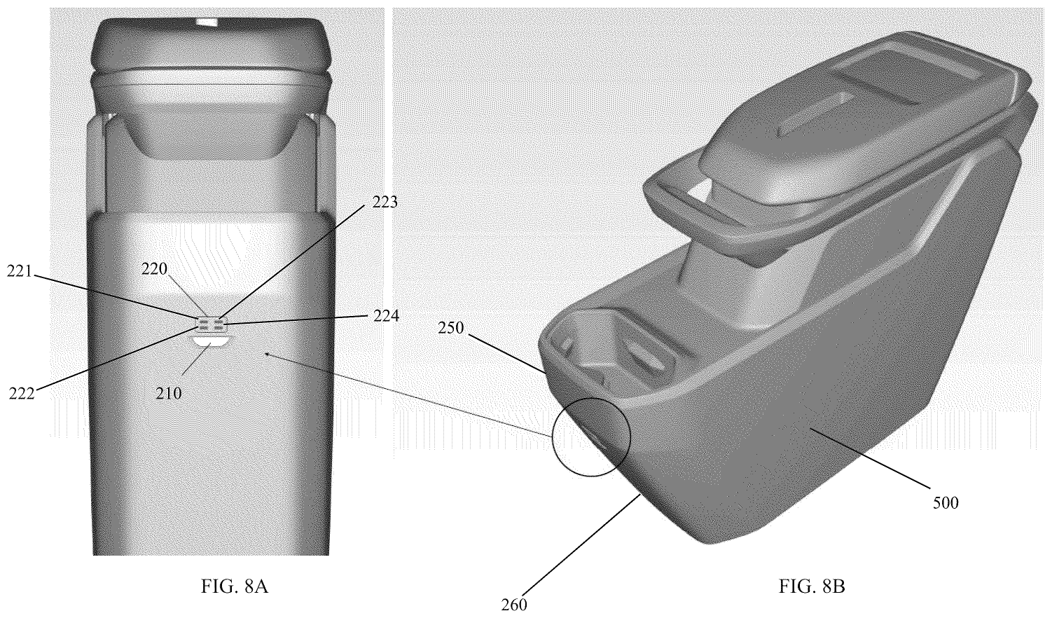

The center console 100 can have a front face 200 and a rear face 300. The front face 200 faces the front of the passenger vehicle (i.e., towards the dashboard and front windshield) and the rear face 300 faces the rear of the passenger vehicle (i.e., towards the back seat area, if present). The front fact 200 can include a vertical portion 250 that is perpendicular or generally perpendicular to the ground while the vehicle is flat on the ground and a slanted portion 260 that slants inward from the vertical portion 250 towards the rear face 300. The front face 200 can include a front electronic connection portion 220 and/or an indicator light 210 (e.g., a light emitting diode (LED) indicator light). Referring to FIGS. 8A and 8B, the front electronic connection portion 220 can include, for example, first to fourth 221, 222, 223, 224 connection ports, each of which can be for example universal serial bus (USB) connection ports (e.g., USB-A, USB-B, and/or USB-C connection ports), though embodiments are not limited thereto. Each connection port can provide a charging function and/or can connect an electronic device into an infotainment system (or an entertainment system) of the passenger vehicle. The indicator light 210 can light up when, for example, a device is connected to the front electronic connection portion 220 (in some cases also if a device is connected to the rear electronic connection portion 320). The indicator light 210, the front electronic connection portion 220, and the cup holder section 115 can be located at a forward area 110 of the center console 110.

The rear face 300 can include a lower slanted portion 360 and a protruded portion 370 that protrudes outward from the remainder of the rear face 300. The rear face 300 can include vents 310 (e.g., air conditioning system vents that provide air from the passenger vehicle's climate control system) and/or a rear electronic connection portion 320. The rear electronic connection portion 320 can include, for example, first 321 and second 322 connection ports, each of which can be for example USB connection ports (e.g., USB-A, USB-B, and/or USB-C connection ports), though embodiments are not limited thereto. Each connection port can provide a charging function and/or can connect an electronic device into an infotainment system (or an entertainment system) of the passenger vehicle. The vents 310, the rear electronic connection portion 320, and the stationary armrest portion 139 can be located at a rear area 120 of the center console 110.

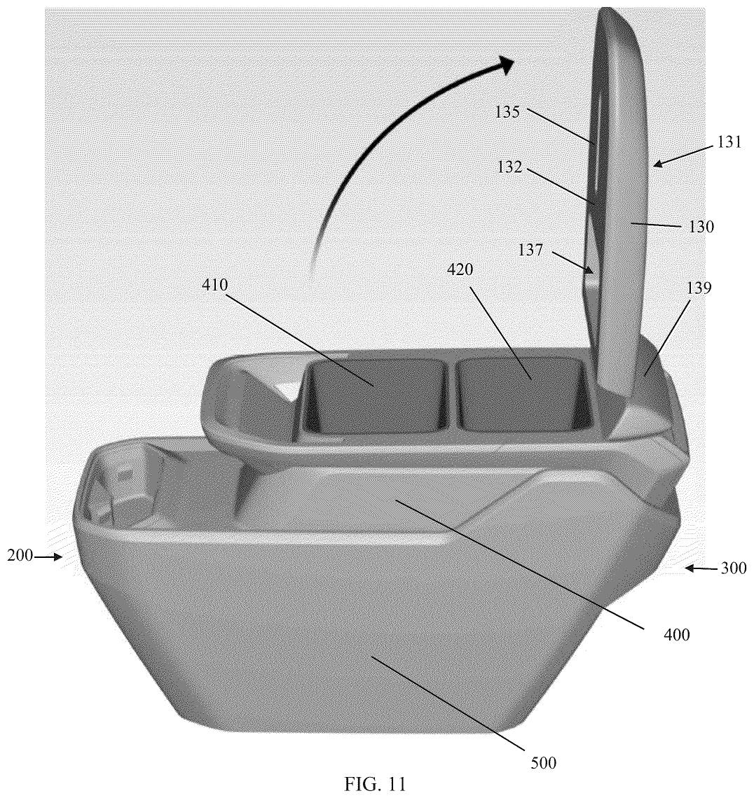

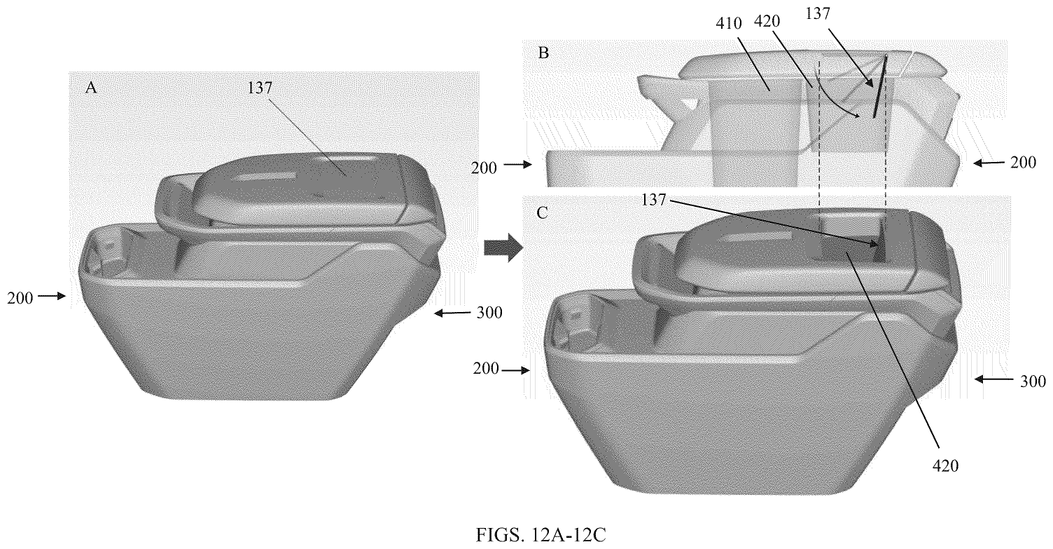

The armrest lid 130 can include an upper surface 131 and a lower surface 132 (see FIG. 11) opposite from the upper surface 131. The armrest lid 130 can include a window 135 that allows a user (e.g., a driver or passenger of the passenger vehicle) to view inside the inner storage area 140. The window 135 can have a transparent cover (e.g., plastic or glass) or can just be an empty space. The armrest lid 130 can also include a swing-top push lid 137 that can be pushed inward towards the inner storage area 400. The swing-top push lid 137 can snap back into place (i.e., closed) when not being pushed in (e.g., via a spring mechanism); see also FIGS. 12A-12C. The window 135 can be disposed forward of the swing-top push lid 137 as depicted in the figures or, alternatively, the swing-top push lid 137 can be disposed forward of the window 135.

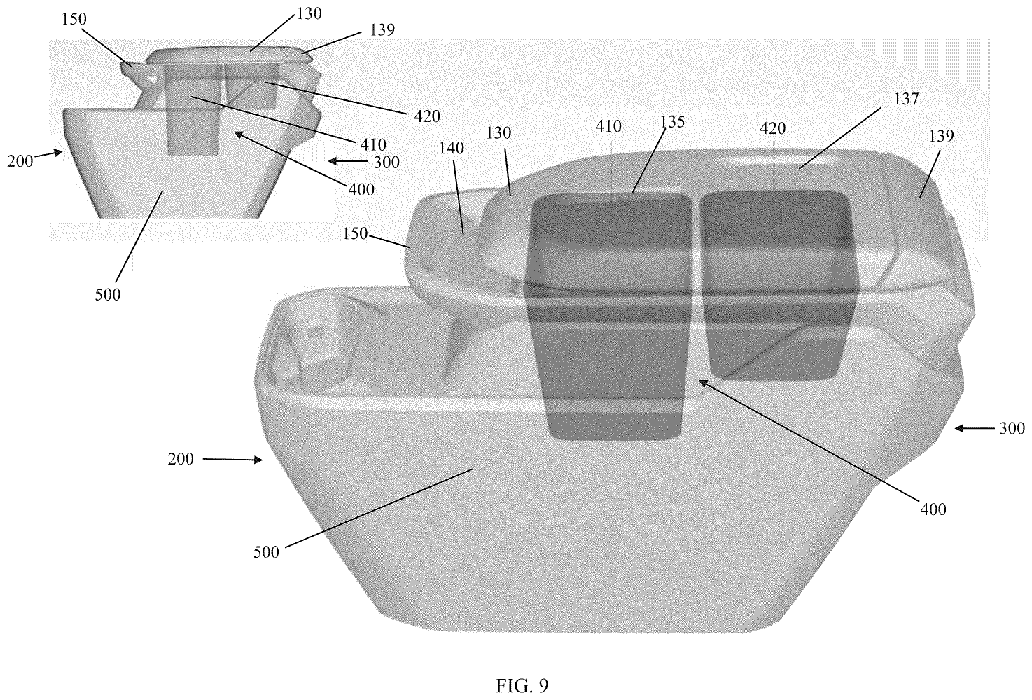

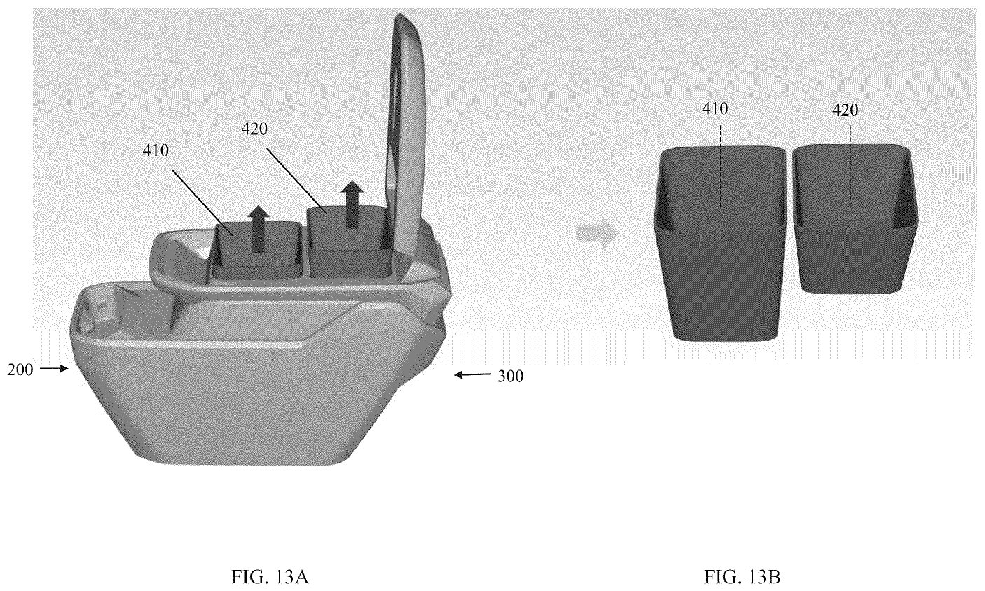

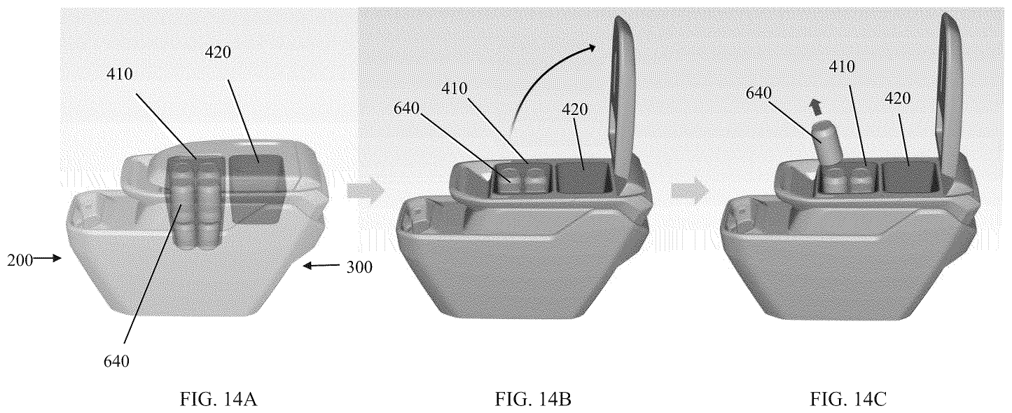

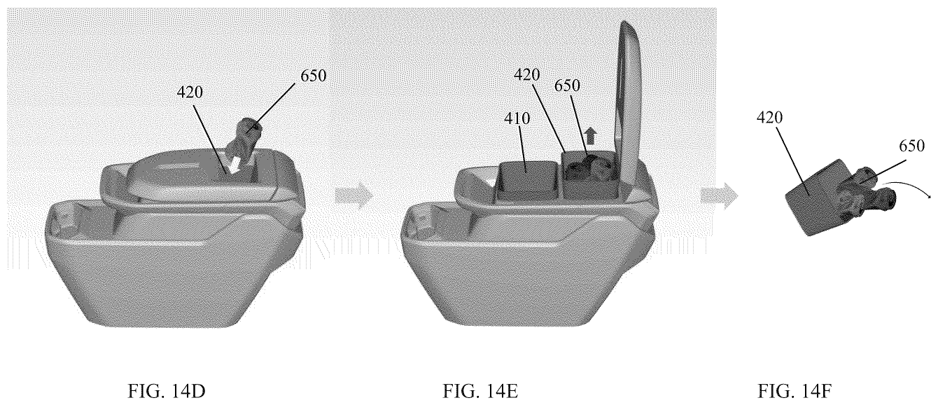

FIGS. 9, 10A, 10B, 11, 12A-12C, 13A, 13B, and 14A-14F show the center console with inner storage containers 410, 420, according to an embodiment of the subject invention. Referring to these figures, the armrest lid 130 can include the window 135 disposed over a first inner storage container 410 and the swing-top push lid 137 over a second inner storage container 420. The inner storage containers 410, 420 can be removable for easy cleaning and/or emptying, as shown in FIGS. 13A, 13B, 14E, and 14F. By opening the swing-top push lid 137 (e.g., by pushing inward on it), objects can be placed in the second inner storage container 420. In this way, the second inner storage container 420 can function as, for example, a waste container.

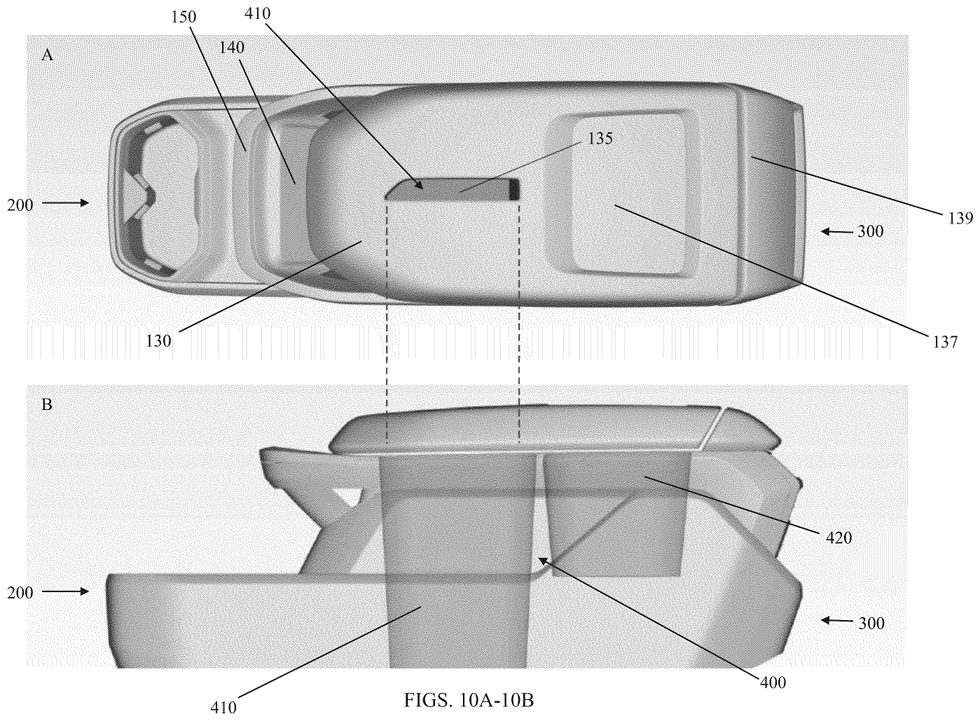

In an embodiment, the first inner storage container 410 disposed forward of the second inner storage container 420 can be larger (e.g., larger volume and/or larger height) than the second inner storage container 420, as seen in FIGS. 10B, 12B, and 13B; though, embodiments are not limited thereto. In alternative embodiments, the second inner storage container 420 can be larger than the first inner storage container 410 or the inner storage containers 410, 420 can be the same size.

Referring to FIGS. 14A-14F, an object 640 can be stored in the first inner storage container 410. The object 640 can be viewed through the window 135 and can be easily accessed by opening the armrest lid 130. Objects 650 (e.g., waste objects) can be easily disposed in the second inner storage container 420 by pushing the swing-top lid 137 to create an opening into the second storage container 420 and then dropping the object 650 therein. If the second storage container 420 contains waste, it can be easily removed for dumping objects 650, as seen in FIGS. 14E and 14F. Though FIGS. 14A-14F depict soda cans 640, 650 as the objects, this is for exemplary purposes only and should not be construed as limiting. Any suitable objects can be stored and/or disposed in the first inner storage container 410 and/or the second inner storage container 420.

In an embodiment, the entire main body 500 (including the front face 200 (excluding the indicator light 210 and the front electronic connection portion 220), the rear face 300 (excluding the rear electronic connection portion 320), the cup holder section 115, the stationary armrest portion 139, the lip 150, the landing area 160, and the sloping section 170) can be monolithically formed. The inner storage containers 410, 420 are configured to be removable and are therefore not monolithically formed with the main body 500.

The center console 100 can be used in a passenger vehicle (i.e., between the front driver seat and the front passenger seat thereof). The center console 100 can be connected to the power, the climate control system, and/or the infotainment system (or entertainment system) of the passenger vehicle. These connections allow for the charging functions, the indicator light function, the vents to be able to provide air, and the ability to connect to the infotainment (or entertainment) system. The passenger vehicle can be, for example, an electric vehicle.

Embodiments of the subject invention provide center consoles for passenger vehicles. The center console has multiple areas for storage, including at least two removable inner storage containers accessible via an armrest lid and/or a swing-top push lid. The center console also provides charging and/or system connection for electronic devices (e.g., smartphones), as well as having air vents for the climate control system for the back seat.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

The subject invention includes, but is not limited to, the following exemplified embodiments.

Embodiment 1. A center console for a passenger vehicle, the center console comprising:
a main body;
an inner storage area comprising at least one removable inner storage container; and
an armrest lid disposed over the inner storage area and having an opened position and a closed position,
wherein when the armrest lid is in the closed position, it closes off the inner storage area and when the armrest lid is in the opened position, it allows access to the inner storage area, and
wherein the armrest lid comprises a swing-top push lid that is configured to be pushed inward towards the inner storage area and allow access thereto when the swing-top push lid is pushed inward.

Embodiment 2. The center console according to embodiment 1, wherein the swing-top push lid is configured to return to a closed position (e.g., via a spring mechanism or similar) when it is not being pushed inward by a user (e.g., a driver or a passenger of the passenger vehicle).

Embodiment 3. The center console according to any of embodiments 1-2, wherein the swing-top push lid is disposed directly over an inner storage container of the at least one inner storage container.

Embodiment 4. The center console according to any of embodiments 1-2, wherein the at least one inner storage container comprises a first inner storage container and a second inner storage container, wherein the first inner storage container is disposed forward of the second inner storage container such that it is closer to a front face of the center console than is the second inner storage container, wherein the front face is configured to face a dashboard and/or front windshield of the passenger vehicle when the center console is disposed therein.

Embodiment 5. The center console according to embodiment 4, wherein the swing-top push lid is disposed directly over the second inner storage container.

Embodiment 6. The center console according to any of embodiments 4-5, wherein the first inner storage container has a larger height and/or volume than does the second inner storage container.

Embodiment 7. The center console according to any of embodiments 4-6, wherein the inner storage area comprises a first section configured to receive and hold in place the first inner storage container (e.g., molded to a shape of the outer surface of the first inner storage container) and a second section configured to receive and hold in place the second inner storage container (e.g., molded to a shape of the outer surface of the second inner storage container).

Embodiment 8. The center console according to any of embodiments 1-7, wherein the armrest lid further comprises a window, which may optionally be disposed forward of the swing-top push lid such that it is closer to the front face of the center console than is the swing-top push lid.

Embodiment 9. The center console according to embodiment 8, wherein the window comprises transparent plastic and/or glass.

Embodiment 10. The center console according to any of embodiments 8-9, wherein the window is disposed directly over the first inner storage container (that is disposed forward of the second inner storage container).

Embodiment 11. The center console according to any of embodiments 1-10, further comprising a charging area outside of and adjacent to the inner storage area, wherein the charging area is disposed forward of the at least a majority of the inner storage area such that it is closer to the front face of the center console than is the at least a majority of the inner storage area.

Embodiment 12. The center console according to embodiment 11, wherein the charging area comprises a wireless charging pad (configured) for charging electronic devices (e.g., smart devices such as smartphones and/or smart tablets).

Embodiment 13. The center console according to any of embodiments 11-12, further comprising a lip disposed around at least a portion of the charging area and configured to inhibit any items disposed in the charging area from falling.

Embodiment 14. The center console according to any of embodiments 1-13, further comprising a cup holder section disposed in a forward area (i.e., adjacent to or near the front face) of the center console and comprising space for at least two cups of the same size or different sizes.

Embodiment 15. The center console according to embodiment 14, further comprising a (flat or approximately flat) landing area adjacent to the cup holder section, wherein the landing area is optionally parallel or approximately parallel (or configured to be parallel or approximately parallel) to a floor of the passenger vehicle when the center console is disposed therein.

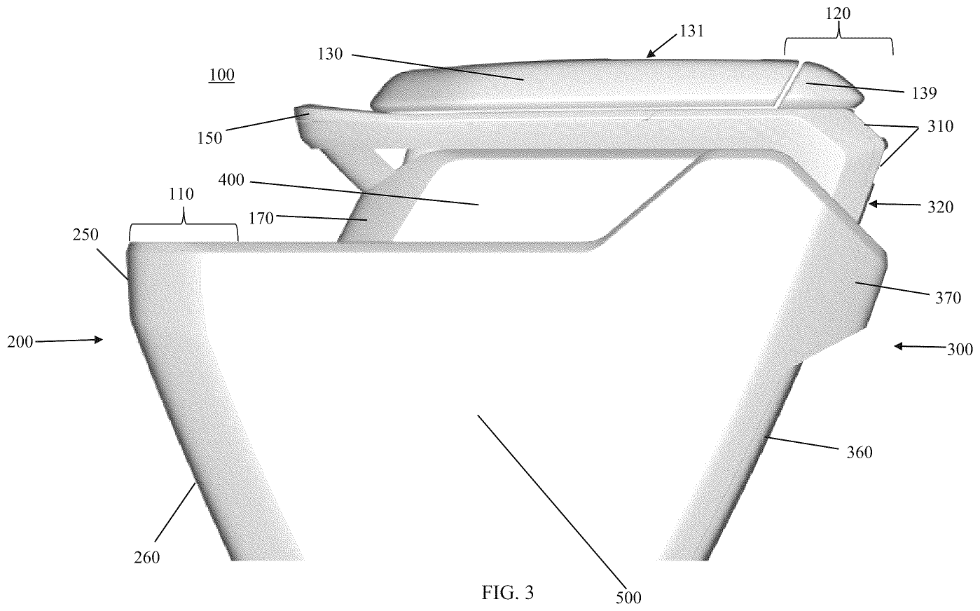

Embodiment 16. The center console according to embodiment 15, further comprising a sloping section disposed between the landing area and the lip and/or the charging area, wherein the sloping section can optionally include a first section that slopes towards a rear face of the center console (opposite from the front face) as it goes from the lip/charging area towards the landing area and/or a second section that slopes towards the front face of the center console as it goes from the lip/charging area towards the landing area (i.e., the sloping section can form a greater-than symbol (“>”) when viewed in cross-section from a left side of the center console; see also FIG. 3), wherein the rear face is configured to face towards a rear of the passenger vehicle when the center console is disposed therein.

Embodiment 17. The center console according to any of embodiments 1-16, further comprising a stationary armrest portion that does not open or close with the armrest lid but instead stays in place while the armrest lid opens, wherein the stationary armrest portion is disposed adjacent to the armrest lid and at a rear area (i.e., adjacent to or near the rear face) of the center console.

Embodiment 18. The center console according to embodiment 17, further comprising a hinge directly connected to the stationary armrest portion and the armrest lid, wherein the hinge is configured to allow the armrest lid to open and close.

Embodiment 19. The center console according to any of embodiments 1-18, wherein a front face of the center console (that is configured to face a dashboard and/or front windshield of the passenger vehicle when the center console is disposed therein) comprises a front electronic connection portion comprising at least one front connection port configured to allow an electronic device to be charged and/or connected to an infotainment/entertainment system of the passenger vehicle when the center console is disposed therein.

Embodiment 20. The center console according to embodiment 19, wherein the front electronic connection portion comprises at least four front connection ports.

Embodiment 21. The center console according to any of embodiments 19-20, wherein each front connection port is a universal serial bus (USB) connection port (e.g., USB-A, USB-B, and/or USB-C connection port).

Embodiment 22. The center console according to any of embodiments 19-21, wherein the front face further comprises an indicator light (e.g., a light emitting diode (LED) indicator light), wherein the indicator light is optionally configured to light up when a device is connected to a front connection port of the front electronic connection portion.

Embodiment 23. The center console according to embodiment 22, wherein the indicator light is disposed adjacent to the front electronic connection portion and is optionally disposed below the front electronic connection portion on the front face.

Embodiment 24. The center console according to any of embodiments 19-23, wherein the front face comprises a vertical portion (that is perpendicular or approximately perpendicular to a floor of the passenger vehicle when the center console is disposed therein) and a slanted portion that slants inward from the vertical portion towards a rear face of the center console (as a lowermost area of the front face is approached), wherein the slanted portion is optionally disposed below the vertical portion on the front face.

Embodiment 25. The center console according to embodiment 24, wherein the front electronic connection portion and the indicator light (if present) is/are disposed on the slanted portion of the front face and optionally closer to the vertical portion than it is (or they are) to a lowermost area of the slanted portion.

Embodiment 26. The center console according to any of embodiments 1-25, wherein a rear face of the center console (that is configured to face a rear of the passenger vehicle when the center console is disposed therein) comprises a rear electronic connection portion comprising at least one rear connection port configured to allow an electronic device to be charged and/or connected to an infotainment/entertainment system of the passenger vehicle when the center console is disposed therein.

Embodiment 27. The center console according to embodiment 26, wherein the rear electronic connection portion comprises at least two rear connection ports.

Embodiment 28. The center console according to any of embodiments 26-27, wherein each rear connection port is a universal serial bus (USB) connection port (e.g., USB-A, USB-B, and/or USB-C connection port).

Embodiment 29. The center console according to any of embodiments 26-28, wherein the rear face further comprises at least one vent (e.g., climate control system vent(s) that provide(s) air from a climate control system of the passenger vehicle when the center console is disposed therein).

Embodiment 30. The center console according to embodiment 29, wherein the at least one vent is disposed above the rear electronic connection portion on the rear face.

Embodiment 31. The center console according to any of embodiments 29-30, wherein the at least one vent comprises at least two vents.

Embodiment 32. The center console according to any of embodiments 26-31, wherein the rear face comprises a lower slanted portion that slants inward towards the front face of the center console (as a lowermost area of the rear face is approached) and a protruded portion that protrudes outward from a remainder of the rear face.

Embodiment 33. The center console according to embodiment 32, wherein the rear electronic connection portion and the at least one vent are disposed above the protruded portion on the rear face.

Embodiment 34. The center console according to any of embodiments 1-33, wherein the front face (excluding the indicator light (if present) and the front electronic connection portion) the rear face (excluding the rear electronic connection portion), the cup holder section (if present®, the stationary armrest portion (if present), the lip (if present), the landing area (if present), and the sloping section (if present) are monolithically formed, wherein the at least one inner storage container is (configured to be) removable and is not monolithically formed with any other elements of the center console.

Embodiment 35. The center console according to any of embodiments 1-34, wherein the center console is configured to be connected to power, a climate control system, and/or an infotainment system (or entertainment system) of the passenger vehicle (when it is disposed therein).

Embodiment 36. The center console according to any of embodiments 1-35, wherein the center console is connected to power, a climate control system, and/or an infotainment system (or entertainment system) of the passenger vehicle.

Embodiment 37. A passenger vehicle, comprising the center console according to any of embodiments 1-36 disposed therein.

Embodiment 38. The passenger vehicle according to embodiment 37, wherein the passenger vehicle is an electric vehicle.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A center console for a passenger vehicle, the center console comprising:
a main body;
an inner storage area comprising at least one removable inner storage container; and
an armrest lid disposed over the inner storage area and having an opened position and a closed position,
wherein when the armrest lid is in the closed position, it closes off the inner storage area and when the armrest lid is in the opened position, it allows access to the inner storage area,
wherein the armrest lid comprises a swing-top push lid that is configured to be pushed inward towards the inner storage area and allow access thereto when the swing-top push lid is pushed inward, and
wherein the swing-top push lid is configured to return to a closed position when it is not being pushed inward by a user of the passenger vehicle.

2. The center console according to claim 1, wherein the at least one inner storage container comprises a first inner storage container and a second inner storage container,
wherein the first inner storage container is disposed forward of the second inner storage container such that it is closer to a front face of the center console than is the second inner storage container, and
wherein the swing-top push lid is disposed directly over the second inner storage container.

3. The center console according to claim 2, wherein the first inner storage container has a larger height and a larger volume than does the second inner storage container.

4. The center console according to claim 2, wherein the inner storage area comprises a first section configured to receive and hold in place the first inner storage container and a second section configured to receive and hold in place the second inner storage container.

5. The center console according to claim 2, wherein the armrest lid further comprises a window disposed forward of the swing-top push lid such that it is closer to a front face of the center console than is the swing-top push lid, and
wherein the window is disposed directly over the first inner storage container.

6. The center console according to claim 5, wherein the window comprises at least one of transparent plastic and glass.

7. The center console according to claim 1, further comprising a charging area outside of and adjacent to the inner storage area, wherein the charging area is disposed forward of at least a majority of the inner storage area,
wherein the charging area comprises a wireless charging pad for charging electronic devices.

8. The center console according to claim 7, further comprising a lip disposed around at least a portion of the charging area to inhibit any items disposed in the charging area from falling.

9. The center console according to claim 1, further comprising a cup holder section disposed in a forward area of the center console and comprising space for at least two cups.

10. The center console according to claim 9, further comprising a flat landing area adjacent to the cup holder section.

11. The center console according to claim 10, further comprising a sloping section disposed between the landing area and a charging area of the center console,
wherein the sloping section comprises a first section that slopes towards a rear face of the center console as it goes from the charging area towards the landing area and a second section that slopes towards a front face of the center console as it goes from the first section towards the landing area.

12. The center console according to claim 1, further comprising a stationary armrest portion that does not open or close with the armrest lid and stays in place while the armrest lid opens,
wherein the stationary armrest portion is disposed adjacent to the armrest lid and at a rear area of the center console.

13. The center console according to claim 12, further comprising a hinge directly connected to the stationary armrest portion and the armrest lid,
wherein the hinge is configured to allow the armrest lid to alternate between the opened position and the closed position.

14. The center console according to claim 1, wherein a front face of the center console comprises an indicator light and a front electronic connection portion comprising at least one front connection port,
wherein each front connection port is configured to allow an electronic device to be: charged; connected to an infotainment system or an entertainment system of the passenger vehicle; or both.

15. The center console according to claim 14, wherein the front face comprises a vertical portion and a slanted portion that slants inward from the vertical portion,
wherein the slanted portion is disposed below the vertical portion on the front face, and
wherein the front electronic connection portion and the indicator light are disposed on the slanted portion of the front face closer to the vertical portion than they are to a lowermost area of the slanted portion.

16. The center console according to claim 1, wherein a rear face of the center console comprises at least one vent and a rear electronic connection portion comprising at least one rear connection port,
wherein each rear connection port is configured to allow an electronic device to be: charged; connected to an infotainment system or an entertainment system of the passenger vehicle; or both, and
wherein the at least one vent is configured to provide air from a climate control system of the passenger vehicle.

17. The center console according to claim 16, wherein the rear face comprises a lower slanted portion that slants inward and a protruded portion that protrudes outward from a remainder of the rear face.

18. A passenger vehicle, comprising:
a driver seat;
a front passenger seat; and
the center console according to claim 1 disposed between the driver seat and the front passenger seat.

19. The passenger vehicle according to claim 18, further comprising:
a source of power;
a climate control system; and
an infotainment system,
wherein the center console is connected to the power, the climate control system, and the infotainment system, and
wherein the passenger vehicle is an electric vehicle.

20. A center console for a passenger vehicle, the center console comprising:
a main body;
an inner storage area comprising at least one removable inner storage container;
a charging area outside of and adjacent to the inner storage area, wherein the charging area is disposed forward of at least a majority of the inner storage area;
a lip disposed around at least a portion of the charging area to inhibit any items disposed in the charging area from falling;
a cup holder section disposed in a forward area of the center console and comprising space for at least two cups;
a flat landing area adjacent to the cup holder section;
a sloping section disposed between the landing area and the charging area;
an armrest lid disposed over the inner storage area and having an opened position and a closed position;
a stationary armrest portion that does not open or close with the armrest lid and stays in place while the armrest lid opens; and
a hinge directly connected to the stationary armrest portion and the armrest lid, wherein the hinge is configured to allow the armrest lid to alternate between the opened position and the closed position,
wherein when the armrest lid is in the closed position, it closes off the inner storage area and when the armrest lid is in the opened position, it allows access to the inner storage area,
wherein the armrest lid comprises a swing-top push lid that is configured to be pushed inward towards the inner storage area and allow access thereto when the swing-top push lid is pushed inward,
wherein the swing-top push lid is configured to return to a closed position when it is not being pushed inward by a user of the passenger vehicle,
wherein the at least one inner storage container comprises a first inner storage container and a second inner storage container,
wherein the first inner storage container is disposed forward of the second inner storage container such that it is closer to a front face of the center console than is the second inner storage container,
wherein the swing-top push lid is disposed directly over the second inner storage container,
wherein the first inner storage container has a larger height and a larger volume than does the second inner storage container,
wherein the inner storage area comprises a first section configured to receive and hold in place the first inner storage container and a second section configured to receive and hold in place the second inner storage container,
wherein the armrest lid further comprises a window disposed forward of the swing-top push lid such that it is closer to the front face of the center console than is the swing-top push lid,
wherein the window is disposed directly over the first inner storage container,
wherein the window comprises at least one of transparent plastic and glass,
wherein the charging area comprises a wireless charging pad for charging electronic devices,
wherein the sloping section comprises a first section that slopes towards a rear face of the center console as it goes from the charging area towards the landing area and a second section that slopes towards the front face of the center console as it goes from the first section towards the landing area,
wherein the stationary armrest portion is disposed adjacent to the armrest lid and at a rear area of the center console,
wherein the front face of the center console comprises an indicator light and a front electronic connection portion comprising at least one front connection port,
wherein each front connection port is configured to allow an electronic device to be: charged; connected to an infotainment system of the passenger vehicle; or both,
wherein the front face comprises a vertical portion and a slanted portion that slants inward from the vertical portion,
wherein the slanted portion is disposed below the vertical portion on the front face,
wherein the front electronic connection portion and the indicator light are disposed on the slanted portion of the front face closer to the vertical portion than they are to a lowermost area of the slanted portion,
wherein the rear face of the center console comprises at least one vent and a rear electronic connection portion comprising at least one rear connection port,
wherein each rear connection port is configured to allow an electronic device to be: charged; connected to the infotainment system of the passenger vehicle; or both,
wherein the at least one vent is configured to provide air from a climate control system of the passenger vehicle, and
wherein the rear face comprises a lower slanted portion that slants inward and a protruded portion that protrudes outward from a remainder of the rear face.
